(19) United States
(12) Patent Application Publication
(10) Pub. No.: US 2013/0236603 A1
(43) Pub. Date: Sep. 12, 2013

(54) Method and Apparatus for Producing Cooked Bacon using Starter Cultures

(71) Applicants: Jon Allan Falk, Milwaukee, WI (US); Mien-Sen Chu, Gurnee, IL (US); Joshua Mathew Hirschuber, Milwaukee, WI (US); Susan Harrits, West Allis, WI (US)

(72) Inventors: Jon Allan Falk, Milwaukee, WI (US); Mien-Sen Chu, Gurnee, IL (US); Joshua Mathew Hirschuber, Milwaukee, WI (US); Susan Harrits, West Allis, WI (US)

(73) Assignee: PATRICK CUDAHY, INC., Cudahy, WI (US)

(21) Appl. No.: 13/866,420

(22) Filed: Apr. 19, 2013

Related U.S. Application Data
(63) Continuation of application No. 12/098,157, filed on Apr. 4, 2008.

(51) Int. Cl. A23L 1/314

(52) U.S. Cl. CPC A23L 1/31472
USPC 426/59; 426/646

(57) ABSTRACT

A method for preparing cooked particulate meat products using a starter culture, such as bacon bits or other bacon seasonings and toppings. The raw meat is ground to a first size in a first grinder, mixed with dry cure which includes a starter culture to form a raw meat mixture, cooled, and stored long enough to allow for partial fermentation. The raw meat mixture is then ground and diced to a second size in a first dicer, evenly spread onto a cooking belt, cooked in one or more continuous cooking ovens to form a cooked meat mixture and diced again to a third size in a second dicer.

### TECHNICAL FIELD

The present invention relates to methods using starter cultures in the preparation of particulate cooked meat products, such as particulate pork products (commonly referred to as bacon bits). More specifically, the present invention relates to a method for cooking particulate meat products, such as bacon bits, using starter cultures and raw meat rather than smoked or similarly prepared meat.

### BACKGROUND OF THE INVENTION

### Raw Pork Bellies

It is known to produce various bacon products from smoked pork bellies. In these processes, the raw pork bellies are typically pumped with a brine solution to cure and flavor the meat, hung in a smoke house and smoked. The smoking process heats the raw bellies to remove moisture and return the bellies to their original weight before being pumped. The lowered water activity level of the pork bellies reduces the likelihood that potentially dangerous (e.g., pathogenic) bacteria can develop in harmful quantities in the fluid. After smoking, the pork bellies are considered bacon slabs. The bacon slabs are typically then pressed into squared shapes and either sliced and packaged or sliced, cooked and packaged.

During slicing, scraps and ends of the bacon slabs are collected for further processing. These remnant parts are often referred to as “ends,” “pieces,” “belly pieces,” and “trim.” The ends and pieces are diced or ground to reduce their size and cooked. Upon cooking, the diced ends and pieces form particulate bacon products, known as bacon topping or bacon bits. These bacon bits are packaged and sold for use as a garnish or ingredient for various foods.

Conventional methods for manufacturing bacon bits have a number of shortcomings. First, conventional processes that rely on ends and pieces are unable to satisfy the present market demand for bacon bits. In addition, current processes are unable to use raw pork bellies that are unsuitable or inconvenient for smoking, such as bellies that are too small or irregularly shaped to be pumped and/or smoked. Another difficulty with producing bacon bits from raw pork bellies is that the proteins contained in the pork bellies tend to mix with salts added during the curing process to form a sticky mixture. As such, the ground pork tends to clump together, inhibiting further processing into suitable sized bacon bits.

Various methods have been proposed to cook raw pork bellies directly into bacon bits without first smoking or otherwise pre-conditioning the pork bellies, and without experiencing undesirable clumping caused by salt mixing with the proteins. One proposed method is disclosed in U.S. Pat. No. 5,798,133 (“the '133 patent”), which is incorporated herein by reference. The '133 patent discloses grinding raw bellies (whether whole or just the ends and pieces), and mixing the ground meat with curing agents, water, and encapsulated salts.

Another proposed method for cooking raw pork bellies into bacon bits is provided in U.S. Pat. No. 6,391,355 (“the '355 patent”), which is incorporated herein by reference. The '355 patent discloses a process similar to that disclosed in the '133 patent, with the additional requirement that the product is heated under a vacuum, still while being agitated, in order to cook the bacon in the absence of oxygen, which may help the product achieve a desirable color. Both the '133 and the '355 patent require continuous agitation of the product during the manufacturing process, which complicates the processing and cooking process.

U.S. Pat. No. 7,008,657 discloses methods for preparing particulate cooked meat products, such as particulate pork products (commonly referred to as bacon bits), using encapsulated salt and raw meat rather than smoked or similarly prepared meat.

Other methods for cooking raw pork bellies comprise grinding then cooking the pork. Still other methods comprise cooking then chilling bacon pieces, then passing the bacon slabs through a dicer. One such process is described in U.S. Pat. No. 4,552,768, which is incorporated herein by reference. These processes also suffer from various shortcomings.

Starter Cultures

Starter cultures are compositions of bacteria or yeast, used in the production of cultured dairy products such as yogurt and cheese, that provide particular characteristics to the food product by fermentation. Starter cultures are used to introduce flavor and aroma; produce alcohol; inhibit undesirable organisms (e.g., reduction of pathogens); and to produce lactic acid (e.g., lactic acid bacteria) as well as the proteolytic and lipolytic activities of the bacteria. Cultures of lactic acid bacteria (e.g., Lactobacillus species) are used extensively as starter cultures in the food and feed industry in the manufacturing of fermented products including dairy products such as cheese, yogurt, and butter, meat products, bakery products, wine, and vegetable products.

U.S. Pat. No. 6,063,410 discloses that starter cultures play several important roles in the fermentation and ripening of dry and semi-dry sausages. The primary function of the starter culture is the acidification process by means of converting the sugar(s) added to the meat mixture into acid. Usually, the sugars added are glucose or sucrose. The acid produced through this fermentation (primarily lactic acid) contributes to the tanginess (acid taste) of the product, promotes water release as the pH is depressed to the iso-electric point of meat proteins to attain the desired final water activity, provides safety against food-borne pathogens or production of enterotoxins, contributes to the final texture by the modification of meat proteins, and also plays a part in the fixing of the red color of meat. The lactic acid bacteria used in starter cultures are usually Pediococcus and Lactobacillus species (e.g., relatively salt tolerant species).

WO 99/21438 discloses a cooked sausage comprising a mixture of meat emulsion and mild yogurt, wherein the yogurt is substantially homogeneously dispersed through the meat emulsion, and the mixture has a pH of about 5.5 or more. The water retaining capacity of the meat is retained, providing a sausage having desirable organoleptic qualities.

U.S. Pat. No. 3,193,391 describes the use of various flavor producing bacteria from the families Lactobacteriaceae and Micrococcaceae for preparing cured meats. This is a related fermentation process for flavor development on large sized meat sections.

U.S. Pat. No. 6,004,592 (“the '592 patent”) discloses that starter culture of lactic acid bacteria in dry and semi-dry sausages and their preparation. The '592 patent discloses that the lactic acid bacteria causes fermentation of carbohydrates to produce the lactic acid which gives the sausage its characteristic flavor and serves to lower the pH of the meat proteins toward their isoelectric point.

U.S. Pat. No. 4,362,750 discloses that chemical and bacteriological changes within the meat emulsion affect proper aging, coloring, and stabilizing of the meat. Since the aging and coloring are related to taste and appearance, control over these changes is required for uniform sausage. The chemical and bacteriological changes can be controlled by inoculating the sausage emulsion with a pure culture. The use of externally added culture is also disclosed in U.S. Pat. No. 2,907,661 which discloses that the fermented type sausages can be prepared by inoculation with a pure lactic acid starter culture such as Pediococcus cerevisiae.

U.S. Pat. No. 4,303,679 describes the use of manganese salts in the fermentation of meat using various species of Pediococcus (i.e., Pediococcus acidilactici or Pediococcus cerevisiae) at manganese levels of 0.5% to 4% by weight of the culture. The bacteria are grown in the presence of a manganese salt, and/or it is added to the culture or to the meat formulation. The meat fermentation is conducted at smokehouse temperatures between 80° F. to 110° F. See also U.S. Pat. No. 2,945,766.

Finally, European Patent 0 770 336 describes a process for preparing meat containing meat trimmings comprising incorporating a frozen suspension of meat trimmings in a brine, marinade, or pickle into chilled meat. Before freezing, these meat trimmings are fermented with a starter culture. See also U.S. Pat. No. 5,968,571.

The present invention provides an alternative method to produce cooked meat products, such as bacon bits, from raw meat, such as whole raw pork bellies and raw pork belly ends and pieces using starter cultures.

### BRIEF SUMMARY OF THE INVENTION

In one aspect the invention provides for a method for preparing particulate cooked meat products. According to one aspect of the present invention, the method comprising: reducing raw meat to a first size; mixing the raw meat with dry cure and a starter culture to form a raw meat mixture; cooling the raw meat mixture; storing the raw meat mixture to allow fermentation; further reducing the raw meat mixture; spreading the raw meat mixture onto a cooking surface; and cooking the raw meat mixture in one or more ovens to form a cooked meat mixture.

In another aspect, the invention provides for a method of using starting cultures for preparing cooked meat product. According to another aspect of the present invention, the method comprises: reducing a ground raw meat mixture comprising raw pork belly meat, dry cure comprising sugar, salt, vegetable juice powder, liquid smoke, inoculated with a starter culture. and water to a first size; storing said raw meat mixture long enough to allow fermentation; spreading the raw meat mixture onto a cooking belt; cooking the raw meat mixture in one or more continuous cooking microwave ovens to form a cooked meat mixture; and reducing the cooked meat mixture to a second size.

In one embodiment, the invention provides for a method of using starting cultures for preparing particulate cooked meat products. According to another aspect of the present invention, the method comprises: reducing raw meat to a first size; mixing the raw meat with dry cure and a starter culture to form a raw meat mixture; cooling the raw meat mixture; storing the raw meat mixture to allow fermentation; further reducing the raw meat mixture; spreading the raw meat mixture onto a cooking surface; and cooking the raw meat mixture in one or more ovens to form a cooked meat mixture.

Preferably, the raw meat comprises raw pork belly meat.

Preferably, the starter culture comprises lactic acid bacteria. More preferably, the starter culture comprises one or more Micrococcus species, Staphylococcus species, Lactobacillus species, or Pediococcus species. More preferably, the starter culture comprises a mixture of one or more Micrococcus species or Staphylococcus species and one or more of a Lactobacillus species or Pedicoccus species. Most preferably, the starter culture comprises a mixture of Staphyloccocus carnosus and Pedicoccus acidlilactici.

Preferably, the starter culture is added in an amount about 10 to about 100 grams per about 600 pounds of raw meat mixture. More preferably, the starter culture is added in an amount about 53 grams per about 600 pounds of raw meat mixture.

Preferably, the starter culture is freeze dried, frozen, lyophilized, spray-dried, or liquid.

Preferably, the raw meat mixture is fermented until its pH is below about 6.5. More preferably, the raw meat mixture is fermented until its pH is below about 6.3.

Preferably, the raw meat mixture is fermented until its pH is above 5.0. More preferably, the raw meat mixture is fermented until its pH is above 5.4.

Preferably, the cooling step of the raw meat mixture cools the raw meat mixture to about 30° to about 45° Fahrenheit. More preferably, the storage step of said raw meat mixture is at about 30° to about 45° Fahrenheit.

Preferably, the raw meat mixture is stored long enough to allow for partial fermentation but not full fermentation. More preferably, the raw meat mixture is stored to allow fermentation for about 6 to about 8 days. Still more preferably, the raw meat mixture is stored to allow fermentation for about 7 days.

Preferably, sugar is added to the raw meat mixture. More preferably, about 1 to about 100 pounds of sugar is added per about 600 pounds of raw meat mixture.

Preferably, salt is added to the raw meat mixture. More preferably, about 1 to about 100 pounds of salt is added per about 600 pounds of raw meat mixture.

Preferably, liquid smoke is added to the raw meat mixture. More preferably, about 1 to about 100 pounds of liquid smoke is added per about 600 pounds of raw meat mixture. Most preferably about 1 to about 100 pounds of natural liquid smoke is added per about 600 pounds of raw meat mixture.

Preferably, a nitrate source is added to the raw meat mixture. More preferably, vegetable juice powder is added to the raw meat mixture as a nitrate source. Most preferably, about 1 to about 100 pounds of vegetable juice powder is added per about 600 pounds of raw meat mixture.

Preferably, the step of cooling the raw meat mixture comprises: cooling the raw meat mixture during the mixing step to a first temperature; and cooling the raw meat mixture after the mixing step to a second temperature.

Preferably, the reducing comprising grinding the raw meat mixture in a grinder.

In one embodiment of the invention, the dry cure and starter culture are added sequentially, in either order, to the raw meat mixture. In another embodiment of the invention, the dry cure and starter culture are added simultaneously to the raw meat mixture.

In another embodiment, the invention further comprising reducing the raw meat mixture after storage. Preferably, the reducing comprises grinding the raw meat mixture in a grinder.

In another embodiment, the invention further comprising dicing the raw meat mixture after storage in a dicer.

In another embodiment, the invention further comprising dicing the cooked meat mixture after cooking.

Preferably, the raw meat mixture is evenly spread onto a cooking surface. Preferably, the cooking surface is a cooking belt. More preferably, the ovens are selected from the group consisting of microwave ovens, convection ovens, and belt grills. Still more preferably, the ovens are one or more continuous cooking ovens. Preferably, the step of cooking the raw meat mixture further comprises cooking the raw meat mixture at a temperature of about 180 to about 210° Fahrenheit.

In another embodiment, the invention further comprising breaking apart the cooked meat mixture.

Another embodiment of the present invention comprises cooked meat mixture obtained by the method of claim 1.

In another aspect, the invention provides a method using starter cultures and apparatus for preparing particulate cooked meat products, such as bacon bits or bacon seasoning. According to one aspect of the present invention, the method comprises the steps of: grinding raw meat to a first size in a first grinder, mixing the ground raw meat with dry cure comprising salt, sugar, liquid smoke, vegetable juice powder, inoculated with a starter culture and water to form a raw meat mixture, cooling the raw meat mixture, and storing the raw meat mixture to allow fermentation. The raw meat mixture is then ground in a second grinder and diced to a second size in a first dicer, evenly spread onto a cooking belt, cooked in one or more continuous cooking ovens to form a cooked meat mixture and diced again to a third size in a second dicer.

According to another aspect of the present invention, the method for preparing particulate cooked meat products is used to process raw pork belly meat into particulate cooked pork products. In this aspect of the invention, the method comprises the steps of: grinding raw meat to a first size in a first grinder, mixing the ground raw meat with dry cure inoculated with a starter culture, and water to form a raw meat mixture. This aspect of the invention further includes the steps of: cooling the raw meat mixture during the mixing step to a first temperature, cooling the raw meat mixture after the mixing step to a second temperature, storing the raw meat mixture for about 7 days to allow fermentation. Further steps of this aspect of the invention include: grinding the raw meat mixture in a second grinder, dicing the raw meat mixture to a second size in a first dicer, evenly spreading the raw meat mixture onto a cooking belt, cooking the raw meat mixture in one or more continuous cooking microwave ovens to form a cooked meat mixture, breaking apart the cooked meat mixture, and dicing the cooked meat mixture to a third size in a second dicer.

According to still another aspect of the present invention, the method for preparing particulate cooked meat products comprises the steps of: grinding and dicing a ground raw meat mixture comprising raw pork belly meat, dry cure inoculated with a starter culture, and water to a first size in a first dicer, evenly spreading the diced ground raw meat mixture onto a cooking belt, cooking the diced ground raw meat mixture in one or more continuous cooking microwave ovens to form a cooked meat mixture, and dicing the cooked meat mixture to a second size in a second dicer.

Yet another aspect of the present invention is an apparatus for preparing particulate cooked meat products. The apparatus of this aspect comprises: a first grinder for grinding raw meat to a first size, a mixer for mixing the ground raw meat with dry cure inoculated with a starter culture and water to form a raw meat mixture, a means for cooling the raw meat mixture, a storage facility for storing the raw meat mixture, a facility for fermentation of the raw meat mixture, a first dicer for dicing the raw meat mixture to a second size, a cooking belt, one or more continuous cooking ovens for cooking the raw meat mixture into a cooked meat mixture, and a second dicer for dicing the cooked meat mixture to a third size.

### BRIEF DESCRIPTION OF THE DRAWINGS

FIG. 1 is a flow diagram of an embodiment of a mixing stage of the present invention;

FIG. 2 is a flow diagram of an embodiment of a cooking stage of the present invention;

FIG. 3 is a flow diagram of an embodiment of a post-cooking process that may be used with the present invention;

FIG. 4 is a diagram of an embodiment of an apparatus for performing various steps of a mixing stage;

FIG. 5 is a diagram of an embodiment of an apparatus for performing various steps of a cooking stage;

FIG. 6 is a diagram of an embodiment of an apparatus for performing various post-cooking processes;

FIG. 7 is a side view of an embodiment of a breaker arm assembly that may be used with the present invention; and

FIG. 8 is the breaker arm assembly of FIG. 7, as viewed from line AA of FIG. 7.

### DETAILED DESCRIPTION OF THE INVENTION

### Meat

The present invention provides a method for cooking meat. In one embodiment, the present invention comprises a method for manufacturing bacon bits from raw pork bellies or portions thereof, such as ends, pieces, trim, belly pieces, or other kinds of meat. Although the description of the present invention refers to pork bellies, or simply “pork” or “meat,” it is understood that this is not intended to limit the scope or applicability of the invention. As used herein, the term “meat” broadly refers to red meat (e.g., beef, pork, veal, buffalo, and lamb or mutton) and poultry meat (e.g., chicken, turkey, ostrich, grouse, goose, guinea, and duck). The meat used in the present invention can be “organic,” “natural,” “Kosher,” and/or “Halal”. The meat can be certified “organic” and/or “natural” by the appropriate state or Federal authorities (e.g., FDA and USDA) and/or by meeting the appropriate standards set forth by said authorities. The meat can be certified to be “Kosher” but the appropriate Rabbinical authorities (e.g., the Orthodox Union, Star-K, OK Kosher Certification) and/or by meeting the appropriate standards set forth by said authorities. The meat can be certified to be “Halal” but the appropriate authorities (e.g., Islamic Food and Nutrition Council of America).

“Reduce,” as used herein, refers broadly to grind, dice, slice, chop up, comminute, pestle, granulate, press, cube, mince, mill, grate, grade, crush, roll, shear, divide, hew, or other method known in the art for changing a meat from one size to another. The resultant size of meat can be a mixture of sizes or a collection of sizes. Mixtures, collections, and assortments of sizes need not be consistent in that the mixture, collection, and assortment can contain particles of different sizes. The resultant sized meat particles can also be uniform or substantially similar in size.

Starter Culture

“Starter culture,” as used herein, refers broadly to an inoculum (composition) of lactic acid bacteria which converts added sugar to lactic acid producing fermented food stuffs. In particular, lactic acid bacteria are Lactobacillus species.

In the present context, the term “lactic acid bacteria” refers broadly to a clade of Gram positive, low-GC, acid tolerant, non-sporulating, non-respiring rod or cocci that are associated by their common metabolic and physiological characteristics. In particular, lactic acid bacteria ferment sugar with the production of acids including lactic acid as well as acetic acid, formic acid, and propionic acid. Lactic acid bacteria are generally regarded as safe (“GRAS”) due to their ubiquitous appearance in food and their contribution to the healthy microflora of human mucosal surfaces. The genera of lactic acid bacteria suitable for use in this invention include but are not limited to Lactobacillus, Leuconostoc, Pediococcus, Micrococcus, Lactococcus, Bifidobacterium, and Enterococcus. Other genera of bacteria suitable for use in this invention include but are not limited to Staphylococcus, Brevibacterium, Arthrobacter and Corynebacterium.

In accordance with the invention, a starter culture can comprise bacteria including but not limited to:

Lactobacillus species including but not limited to Lactobacillus acidophilus, Lactobacillus brevis, Lactobacillus buchneri, Lactobacillus casei, Lactobacillus curvatus, Lactobacillus delbrueckii, Lactobacillus fermentum, Lactobacillus helveticus, Lactobacillus plantarum, Lactobacillus reuteri, Lactobacillus sakei, Lactobacillus salivarius;

Leuconostoc species including but not limited to Leuconostoc carnosum, Leuconostoc citreum, Leuconostoc durionis, Leuconostoc fallax, Leuconostoc ficulneum, Leuconostoc fructosum, Leuconostoc garlicum, Leuconostoc gasicomitatum, Leuconostoc gelidum, Leuconostoc inhae, Leuconostoc kimchii, Leuconostoc lactis, Leuconostoc mesenteroides, Leuconostoc pseudoficulneum, Leuconostoc pseudomesenteroides;

Pediococcus species including but not limited to Pediococcus acidilactici, Pediococcus acidilati, Pediococcus cellicola, Pediococcus cerevisiae, Pediococcus claussenii, Pediococcus damnosus, Pediococcus dextrinicus, Pediococcus ethanolidurans, ediococcus inopinatus, ediococcus parvulus, Pediococcus pentosaceus, Pediococcus stilesii;

Micrococcus species including but not limited to Micrococcus antarcticus, Micrococcus freudenreichii, Micrococcus luteus, Micrococcus lylae, Micrococcus mucilaginosis, Micrococcus roseus, Micrococcus varians;

Staphylococcus species including but not limited to Staphylococcus carnosus, Staphylococcus sp. strain N9A, Staphylococcus xylosus;

Lactococcus species including but not limited to Lactococcus lactis, Lactococcus garvieae, Lactococcus piscium, Lactococcus plantarum, Lactococcus raffinolactis; and mixtures thereof.

A preferred brand of starter culture is from Chr. Hansen A/S, Boge Allé 10-12, DK-2970 Horsholm Denmark (Product No. CS299). In still another embodiment, the starter culture used is Chr. Hansen CS299 (Staphyloccoccus carnosus) plus CSB (a mixture of Pediococcus acidilactici and Staphylococcus carnosus).

When lactic acid bacteria are cultured in milk or any other starting material, the medium becomes acidified as a natural consequence of bacterial growth. In addition to the production of lactic acid/lactate from citrate, lactose or other sugars, several other metabolites (e.g., acetaldehyde, α-acetolactate, acetoin, acetate, ethanol, carbon dioxide, diacetyl and 2.3-butylene glycol (butanediol)) may be produced during the growth of the lactic acid bacteria. Generally, the growth rate and the metabolic activity of lactic acid bacteria starter cultures can be controlled by selecting appropriate growth conditions for the strains of the specific starter culture used such as appropriate growth temperature, oxygenation, and nutrients.

As it is normal in lactic acid bacterial fermentation processes to apply mixed cultures of lactic acid bacteria, the starter culture used according to the invention may in certain embodiments comprise multiple strains either belonging to the same species or belonging to different species. Accordingly, in a further embodiment, the starter culture comprises cells of two or more different lactic acid bacteria strains. Further, Micrococcus or Staphylococcus species can be used to convert nitrate to nitrite and give the typical cured pink color. Lactobacillus or Pediococcus species can be used for fermentation (e.g., lactic acid production). A typical example of such a useful combination of lactic acid bacterial cells in a starter culture composition is a mixture of Pediococcus cerevesiae and Lactobacillus plantarum; Pediococcus cerevesiae and Lactobacillus plantarum; and Micrococcus spp. mixed with either Pediococcus cerevesiae or Lactobacillus plantarum; and Pediococcus acidilactici and Staphylococcus carnosus; and a mixture of one or more Micrococcus species or Staphylococcus species and one or more of a Lactobacillus species or Pedicoccus species.

It will be understood, that the starter culture, when added to the raw meat mixture, is added under different conditions than normally, such as a lower pH, and thus it may be useful to design a specific starter culture which is capable to perform the desired activities under the fermentation conditions. Thus, it will be appreciated that such a lactic acid bacteria can be a wild-type strain, a mutant strain, a metabolically engineered strain or a genetically modified strain of any kind of bacterium useful in the food industry. As used herein the expression “genetically modified bacterium” is used in the conventional meaning of that term (i.e., it includes strains obtained by subjecting a strain to conventionally used mutagenisation treatments including treatment with a conventional chemical mutagen or to spontaneously occurring mutants.) Furthermore, it is possible to provide genetically modified lactic acid bacteria by random mutagenesis or by selection of spontaneously occurring mutants.

From a food safety (contamination) point of view it is important that the introduced starter culture is biologically pure (e.g., it should only contain the desired microorganisms and/or enzymes and no or only few foreign microorganisms as contaminating organisms.) In food products contamination with undesired or spoilage bacteria, fungi and bacteriophages is particularly serious, as such organisms may attack the lactic acid bacterial starter culture (i.e., the microorganisms) resulting in fermentation failures.

The starter culture composition used in the invention may be provided in any form, including but not limited to a liquid, frozen, dried, freeze-dried, lyophilized, or spray-dried. The starter culture may be mixed in water, as is conventional, before addition to the raw meat mixture.

The starter culture can be added to the dry cure and/or the raw meat mixture wherein the starter culture contains from 10⁶ to 10¹³ viable cells per milliliter (mL), preferably 10⁷ to 10⁹ viable cells per milliliter, 10⁸ to 10⁹ viable cells per milliliter, or preferably 10⁸ to 10¹⁰ viable cells per milliliter.

Alternatively, the starter culture can added in an amount about 0.1% to 10% based upon the weight of the raw meat mixture. Preferably, the starter culture is added in an amount about 0.1% to 1%, 1% to 5%, or 5% to 10%. More preferably, the starter culture is added in an amount about 1%, 2%, 5%, 7%, or 10%.

In another embodiment, the starter culture can be added in an amount about 10 to 100 milliliter (mL) per about 600 pounds of raw meat mixture. In still another embodiment, the starter culture can be added in an amount about 10, 20, 30, 40, 50, 60, 70, 80, 90, or 100 mL per about 600 pounds of raw meat mixture. The starter culture is preferably can be added in an amount about 40 to 60 mL per about 600 pounds of raw meat mixture and more preferably from about 50 to 55 mL per about 600 pounds of raw meat mixture, most preferably about 53 mL per about 600 pounds of raw meat mixture.

In another embodiment, the starter culture can be added in an amount about 10 to 100 grams (g) per about 600 pounds (lbs.) of raw meat mixture. In still another embodiment, the starter culture can be added in an amount about 10, 20, 30, 40, 50, 60, 70, 80, 90, or 100 grams per about 600 pounds of raw meat mixture. The starter culture preferably can be added in an amount about 40 to about 60 grams per about 600 pounds of raw meat mixture and more preferably from about 50 to about 60 grams per about 600 pounds of raw meat mixture, and most preferably about 53 grams per about 600 pounds of raw meat mixture. In still another embodiment, the starter culture is added at about 160 grams per about 1,800 pounds of raw meat mixture.

Raw meat mixture and/or dry cure can be inoculated with the starter culture by means of injection, soaking, addition, mixing, grinding, coating, or any other method or combination of methods.

Fermentation Conditions

Generally, fermentation conditions are defined by temperature, time, pH, and moisture. The end point of growth is usually determined by time or measurement of pH. In preparing the cultured products of the present invention, the use of standard techniques for good bacteriological growth are used.

Fermentation Conditions—Temperature

The fermentation may take place at a temperature of from 30° to 113° Fahrenheit (F). The fermentation may take place at a temperature at about 30° Fahrenheit and about 45° Fahrenheit, preferably about 35° to about 40° Fahrenheit, and most preferably at about 40° Fahrenheit.

Fermentation Conditions—Time

The fermentation of the raw meat mixture comprising a starter culture may take place over a period about 1, 2, 3, 4, 5, 6, 7, 8, 9, or 10 days. Preferably the fermentation of the raw meat mixture comprising a starter culture may take place over a period about 5 to about 9 days, preferably from about 6 to about 8 days, and most preferably about 7 days.

Fermentation Conditions—pH

Fermentation is continued until the desired endpoint is reached, in particular until a pH within the range above about 5.0 to below about 7.0. In another embodiment, fermentation is continued until a pH level above about 5.0 to below about 6.5 is reached, more preferably until a pH level of above about 5.4 but below about 6.3 is obtained. Also, fermentation may be conducted where the pH level is above about 5.4 but below about 6.3. Alternatively, fermentation is continued until the pH level drops below about 6.3 but above about 5.4.

Fermentation Conditions—Partial Fermentation

In a preferred embodiment, the fermentation is partial fermentation. “Partial fermentation”, as used herein, refers broadly to fermenting the raw meat mixture to allow the production of lactic acid by the lactic acid bacteria, the binding of the acid to the meat, and the partial denaturing of the meat but imparting little or no discernable “tangy” flavor. Partial fermentation also allows for binding to the meat but does not leave the meat too “sticky” as to hamper (interfere with) spreading the meat on a conveyor belt for cooking. Partial fermentation is conducted for a shorter period of time than full fermentation. In one embodiment, partial fermentation comprises adding about 53 g (˜53 mL) of lactic acid starter culture to about 600 pounds of raw meat mixture and fermenting about 35 to 40° Fahrenheit for about 7 days at a pH level below about 6.5 but above about 5.0, most preferably below about 6.3 and above about 5.4.

Fermentation Conditions—Dry Cure Composition

In one embodiment a dry cure is added to the raw meat mixture. In another embodiment it is preferred to add (1) sugar including but not limited to sucrose, raw sugar, natural sugar, organic sugar, brown sugar, organic cane syrup, organic cane sugar, white sugar, natural brown sugar, muscovado sugar, refined sugar, molasses, confectioners' sugar (powdered sugar), fruit sugar, milk sugar, malt sugar, granulated guar, beet sugar, superfine (castor) sugar); (2) salt including but not limited to natural salt, natural sea salt, natural rock salt, sea salt, sodium chloride, table salt, natural hand-harvested salt, rare artisan salt, smoked sea salt, gourmet sea salt); (3) water; (4) a nitrate source including but not limited vegetable juice powder; (5) liquid smoke; (6) spices (in liquid or powder form); (7) seasonings (in liquid or powder form); and (8) any combination of (1)-(7) to the dry cure and/or raw meat mixture. In another embodiment, any one, all, or a combination of (1)-(7) can be added to the raw meat mixture individually, in any order, or simultaneously. Alternatively, the dry cure composition can comprise any one, all, or a combination of (1)-(7) which can be added to the dry cure individually, in any order, or simultaneously. It is preferred that natural cane sugar and sea salt are added to the dry cure and/or raw meat mixture. In a preferred embodiment, natural cane sugar, sea salt, water, vegetable juice powder, liquid smoke, spices, and seasonings are added to the dry cure and/or raw meat mixture.

In one embodiment, sugar can be added in an amount about 1 pound to 100 pounds per about 600 pounds of raw meat mixture. In another embodiment, sugar can be added in an amount about 1, 2, 3, 4, 5, 6, 7, 8, 9, 10, 11, 12, 13, 14, 15, 16, 17, 18, 19, 20, 30, 40, 50, 60, 70, 80, 90, or 100 pounds per about 600 pounds of raw meat mixture. Sugar is preferably added in an amount about 5 to 20 pounds per about 600 pounds of raw meat mixture and more preferably from 8 pounds per about 600 pounds of raw meat mixture, most preferably about 10 pounds per about 600 pounds of raw meat mixture. In another embodiment, about 30 pounds of sugar are added to about 1800 pounds of raw meat mixture.

In one embodiment, salt can be added in an amount about 1 pound to 100 pounds per about 600 pounds of raw meat mixture. In another embodiment, salt can be added in an amount about 1, 2, 3, 4, 5, 6, 7, 8, 9, 10, 11, 12, 13, 14, 15, 16, 17, 18, 19, 20, 30, 40, 50, 60, 70, 80, 90, or 100 pounds per about 600 pounds of raw meat mixture. Salt is preferably added in an amount about 5 to 20 pounds per about 600 pounds of raw meat mixture and more preferably from 8 pounds per about 600 pounds of raw meat mixture, most preferably about 10 pounds per about 600 pounds of raw meat mixture. In another embodiment, about 30 pounds of salt are added to about 1800 pounds of raw meat mixture.

In one embodiment, water can be added in an amount about 1 pound to 100 pounds per about 600 pounds of raw meat mixture. In another embodiment, water can be added in an amount about 1, 2, 3, 4, 5, 6, 7, 8, 9, 10, 11, 12, 13, 14, 15, 16, 17, 18, 19, 20, 30, 40, 50, 60, 70, 80, 90, or 100 pounds per about 600 pounds of raw meat mixture. Water is preferably added in an amount about 5 to 20 pounds per about 600 pounds of raw meat mixture and more preferably from 8 pounds per about 600 pounds of raw meat mixture, most preferably about 10 pounds per about 600 pounds of raw meat mixture. In another embodiment, about 30 pounds of water are added to about 1800 pounds of raw meat mixture.

In one embodiment, liquid smoke can be added in an amount about 1 pound to about 100 pounds per about 600 pounds of raw meat mixture. Liquid smoke (smoke condensates) are generally produced through the controlled burning of wood chips or sawdust. This forms a smoke cloud that is extracted with water to dissolve the smoke components in the water forming a base smoke solution. This base can be modified through many methods to develop a wide range of smoke flavors. In another embodiment, liquid smoke can be added in an amount about 1, 2, 3, 4, 5, 6, 7, 8, 9, 10, 11, 12, 13, 14, 15, 16, 17, 18, 19, 20, 30, 40, 50, 60, 70, 80, 90, or 100 pounds per about 600 pounds of raw meat mixture. Liquid smoke is preferably added in an amount about 1 to about 10 pounds per about 600 pounds of raw meat mixture and more preferably about 2 pounds per about 600 pounds of raw meat mixture, most preferably about 3 pounds per about 600 pounds of raw meat mixture. In another embodiment, about 12 pounds of liquid smoke are added to about 1800 pounds of meat. In still another embodiment, organic liquid smoke can be added in an amount about 1 pound to about 100 pounds per about 600 pounds of raw meat mixture. In yet another embodiment, natural liquid smoke can be added in an amount about 1 pound to about 100 pounds per about 600 pounds of raw meat mixture. A preferred brand of natural liquid smoke is Red Arrow LF-BN®, although other commercially available brands of natural liquid smoke can be used such as COLGIN NATURAL LIQUID SMOKE, BUTCHER & PACKER NATURAL LIQUID SMOKE FLAVORING, and LAZY KETTLE BRAND ALL NATURAL LIQUID SMOKE.

In one embodiment, a nitrate source can be added in an amount about 1 pound to 100 pounds per about 600 pounds of raw meat mixture. Nitrate sources that can used in the invention include but are not limited to vegetable juice powder, sea salt, celery juice, celery juice powder, tea extract, spinach juice concentrate, and spinach juice concentrate powder. In another embodiment, the nitrate source can be added in an amount about 1, 2, 3, 4, 5, 6, 7, 8, 9, 10, 11, 12, 13, 14, 15, 16, 17, 18, 19, 20, 30, 40, 50, 60, 70, 80, 90, or 100 pounds per about 600 pounds of raw meat mixture. Preferably, the vegetable juice powder is added in an amount about 1 to about 10 pounds per about 600 pounds of raw meat mixture and more preferably from about 2 pounds per about 600 pounds of raw meat mixture, most preferably about 3 pounds per about 600 pounds of raw meat mixture. In another embodiment, about 12 pounds of vegetable juice powder are added to about 1800 pounds of raw meat mixture. In still another embodiment, an organic nitrate source can be added in an amount about 1 pound to about 100 pounds per about 600 pounds of raw meat mixture. In yet another embodiment, a natural nitrate source (e.g., vegetable juice powder) can be added in an amount about 1 pound to about 100 pounds per about 600 pounds of raw meat mixture.

Agents for promoting bacterial growth can also be added to the dry cure and/or raw meat mixture, if desired. These agents include carbohydrates including but not limited to sucrose, raw sugar, natural sugar, organic sugar, brown sugar, organic cane syrup, organic cane sugar, white sugar, natural brown sugar, muscovado sugar, refined sugar, molasses, confectioners' sugar (powdered sugar), fruit sugar, milk sugar, malt sugar, granulated guar, beet sugar, superfine (castor) sugar); a protein containing growth stimulant including but not limited to yeast extract; minerals including but not limited to magnesium and manganese; antioxidants; phage control agents, vitamins, pH regulating agents including but not limited to buffers; aroma compounds; flavoring agents; coloring agents; stabilizers; thickeners; acids; commercial gums including but not limited to dextran, gellan, rhansan, xanthan, and welan; bacteriocides; enzymes including but not limited to chymosin, amylase, glucose isomerase, pectinase, glucose oxidase; and fungicides. Protein additives can be added after fermentation. When the additives do not contribute acidity and act as buffers, the initial acidity of the ferment can be adjusted to compensate for this buffering effect.

### DETAILED EMBODIMENTS

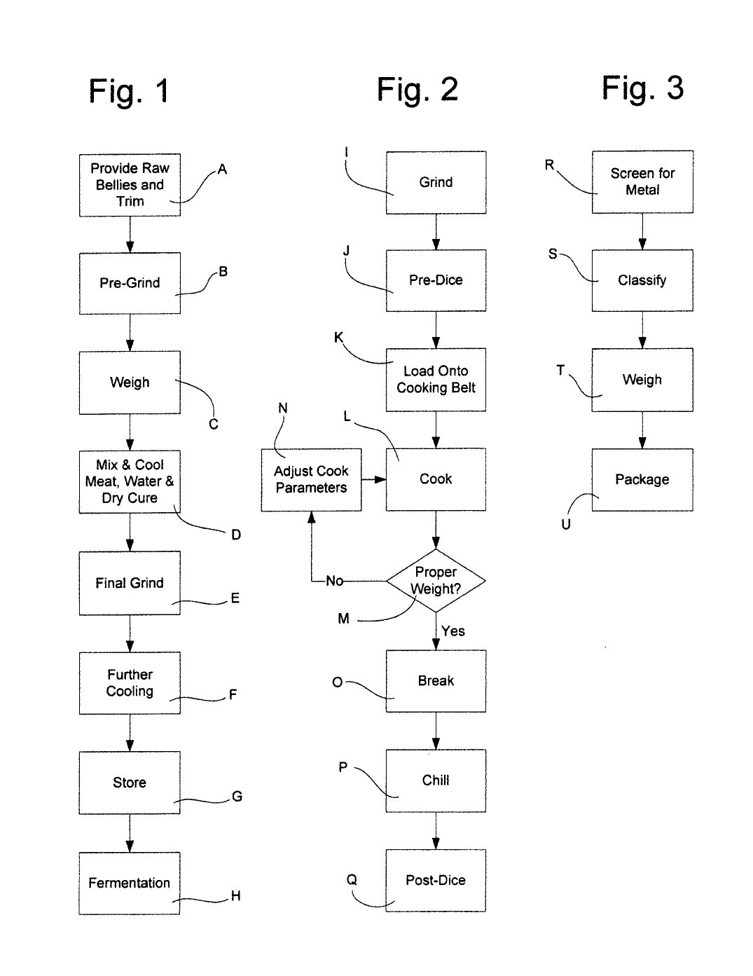

Referring now to the Figures, a process and apparatus of the present invention, and various exemplary and preferred embodiments thereof, are described. FIGS. 1, 2, and 3 are flow charts graphically depicting the mixing, fermentation, cooking, and post-processing stages, respectively, of a preferred embodiment of the present invention. During the mixing stage, raw pork is sized and cured in preparation for cooking. During the fermentation stage, the raw pork mixture undergoes partial fermentation. During the cooking stage, the raw pork mixture is cooked and sized to its final size. During the post-processing stage, the cooked pork is prepared for distribution. It will be understood that in various embodiments certain steps in each of the stages described herein may be reordered, supplemented or omitted, and entire stages may be omitted altogether. Furthermore, the various embodiments of the present invention can be practiced to be in compliance with organic, natural, Kosher, and/or Halal standards to produce a organic, natural, Kosher, and/or Halal meat products.

Referring now to FIG. 1, various steps in an embodiment of a mixing stage are described. In step A, raw meat is provided. As noted before, the raw meat may be any type of pork or other meat, however it is preferred that the meat be raw pork belly meat (e.g., whole raw pork bellies and/or parts of raw pork bellies). One reason raw pork bellies are preferred is because they provide a flavorful product. Another reason raw pork bellies are preferred is because they have a fat content that facilitates cooking the meat without adding a liquid cooking medium (e.g., fat or oil).

The raw meat is reduced in size to facilitate the even application of curing agents, coloring, and flavoring. Preferably, the raw meat is reduced in size using a grinder in pre-grind step B. Any suitable grinder may be used for step B, including, for example, those available from Weiler and Company, Inc. of Whitewater, Wis.. It has been found that using a 1/2″ plate (i.e., an outlet plate having 1/2″ openings) in the pre-grinding step B provides a suitable, uniformly cured, colored and flavored product. Other size grinders also may be used depending on the desired characteristics of the final product, and grinders having plate sizes of between about 1/4″ and about 2″ may be used with the present invention. In other embodiments, step B may be replaced with a dicing step or any other size-reducing step in lieu of the grinding step.

After the raw meat is reduced in size in step B, it is mixed with water and dry cure ingredients. In order to provide high quality products, the raw meat preferably is measured before mixing with dry cure, water, and other cooking ingredients to provide the proper proportion of each ingredient, although this step is not necessary to the present invention. Any number of methods may be used to provide the appropriate amount of raw meat to the mixing process. For example, the raw meat may be measured according to volume or weight and an appropriate amount selected for mixing with a known quantity of dry cure and water. It is believed that weighing the raw meat provides the most accurate measurement for purposes of creating the proper mixture of raw meat, dry cure and water. It is preferred to weigh the raw meat after pre-grind step B, rather than before, because the weight of the raw meat may be reduced during grinding as bone particles and other inclusions are extracted.

In a preferred embodiment, the raw meat is conveyed to one or more silos or other holding devices and weighed, in step C, to provide an appropriate amount of raw meat to be mixed with the dry cure and water. The silos preferably are mounted on load cells to measure the weight of the silo and the meat contained therein. Each silo preferably is equipped with a loss-in-weight control system that may be used in conjunction with the load cell to accurately measure the amount of raw meat that is deposited from the silo, thereby providing an accurate method of determining the amount of raw meat being sent to the mixer. Load cells and loss-in-weight controllers are known in the art and available, for example, from Hardy Instruments, Inc. of San Diego, Calif., which provides the HI 2160 Plus Loss-In-Weight Controller. Other weighing methods and systems will be readily apparent to those of ordinary skill in the art in light of the teachings herein.

The raw meat is mixed with dry cure and water in step D to form a raw meat mixture. A single-shaft, twin-shaft, or intermeshing twin-shaft mixer from Wolfking A/S of Denmark, is preferred for use with the present invention, although other suitable mixers may be used. The dry cure ingredients, which may include any conventionally known ingredients, preserve, flavor and color the meat and provide various other functions as known in the art. In a preferred embodiment, the dry cure comprises a commercially available mixture of 6.25% sodium nitrite and 93.75% salt (by weight) commonly referred to as Prague Powder #2. The dry cure also may comprise other ingredients, such as sodium erythrobate to accelerate the curing process, sodium phosphate to bind water, and sugar to sweeten the final product or provide a carbohydrate source for fermentation. In some cases, the use of certain cure ingredients, such as sodium nitrate, may be dictated by legal requirements or prohibitions, and it is preferred, although not required, that the dry cure ingredients be selected to comply with all applicable legal requirements. The selection of cure ingredients to provide different flavors or other benefits to the final product is well known in the art.

The dry cure can be inoculated with a starter culture. For instance, a lactic acid bacteria starter culture Chr. Hansen product number CS299, available from Chr. Hansen A/S, Boge Allé10-12, DK-2970 Horsholm Denmark can added at about 53 g per about 600 pounds of raw meat mixture.

The dry cure also can comprise sugar, salt, water, liquid smoke, a nitrate source (e.g., vegetable juice powder), spices, and/or seasoning. Additionally, sugar, salt, water, liquid smoke, a nitrate source (e.g., vegetable juice powder), spices, and/or seasoning can be added to the raw meat mixture simultaneously or individually in any order.

Water is added to the mixture to increase the water content of the final product to help it emulate genuine bacon in flavor and texture. The water also assists with the even distribution of the dry cure ingredients.

In a preferred embodiment the meat, dry cure and water are cooled during mixing step D. Cooling reduces the likelihood of bacterial growth and has also been found to improve product handling in further steps. A preferred cooling method is to directly spray a cooling agent, preferably liquid or gaseous carbon dioxide (CO₂), onto the raw meat mixture as it is being mixed. It is contemplated, however, that other gasses or liquids may be used as a cooling agent. In addition, other cooling methods may be used in lieu of direct spraying. For example, the mixer may be encased in a cooling jacket or otherwise be refrigerated.

The CO₂ preferably is sprayed directly onto the raw meat and other ingredients as they are being mixed in the mixer to reduce the raw meat mixture's temperature to about 30 to 45° Fahrenheit, and preferably to about 35 to 40° Fahrenheit. The mixers may be equipped with covers to isolate the raw meat mixture from atmospheric air during mixing and prevent the escape of the cooling agent. The use of gaseous or liquid CO₂ has been found to provide the additional benefit that crystals form during the mixing and cooling step D and become entrained in the raw meat mixture. When the crystals melt and/or sublimate they undergo an endothermic reaction as they change phase and become fluid, thereby absorbing heat from their surroundings and further cooling the raw meat mixture. It has been found that the temperature of the raw meat mixture may continue to decline to about 35° Fahrenheit even after the mixing and cooling step D stops.

After the meat, dry cure and water are mixed into a raw meat mixture, the raw meat mixture may be ground in a final grinding step E to further agitate the mixture or facilitate its conveyance. The final grinding step also may be useful to help break up frozen formations that may cause the raw meat to aggregate into clumps, and possibly also reduce the likelihood that such aggregations will form during further cooling and storage. In one embodiment, the raw meat mixture is passed through a grinder having a relatively large plate size, such as a 2″ plate or larger. The grinder used in this step preferably is one such as those available from Wolfking A/S of Denmark, or may be any other conventional grinder, such as those described elsewhere herein. In other embodiments, the final grind step E may be omitted in its entirety.

As noted before, the use of gaseous or liquid CO₂ (or other suitable liquid or low temperature gas) has been found to provide additional cooling. This post-mixing cooling is illustrated as step F in FIG. 1. This additional cooling may be supplemented by other cooling processes, such as refrigeration. Of course, if CO₂ cooling is not used, refrigeration may be mandatory to achieve the final product temperature for storage and further processing.

The cooled raw meat mixture is stored in step G for a period of time prior to cooking to allow the sodium nitrite to cure the meat. It should be noted that the second cooling step F may be combined with the storage step G, and the raw meat mixture preferably is stored in a refrigerated enclosure. During this time, the endothermic melting and/or sublimation of crystals formed in the mixing step D may continue to cool the meat mixture, thereby reducing the amount of additional cooling required to keep the raw meat mixture at the proper temperature during storage. In step H the raw meat mixture is fermented for about 5 days at a temperature of about 35-40° Fahrenheit. Additionally, the fermentation may be at a pH level below about 6.5 but above about 5.0. The raw meat mixture is preferably fermented for about 7 days at a temperature at about 40° Fahrenheit. Longer fermentation times, up to about 8 to about 10 days, may be acceptable provided the final product provides acceptable color, flavor, and consistency. Shorter fermentation times of about 2 to about 4 days also may be acceptable provided the quality of the final product is not compromised.

Referring now to FIG. 2, various steps in an embodiment of a cooking stage are described. The first steps in the cooking stage are to remove the fermented raw meat mixture from storage and fermentation. The fermented raw meat mixture is ground in step I in a second grinder and then pre-diced in step J. When the meat mixture is cooled the individual particles of raw pork may become frozen together. The pre-dicing step J breaks up any large aggregations of raw meat particles.

The pre-dicing step J may be performed using any conventional dicing machine. In a preferred embodiment, a MODEL M DICER, available from Urschel Laboratories, Inc. of Valparaiso, Ind., is used. The size of the dicing blades is selected to break up the meat aggregations and size the meat particles to facilitate their cooking. It has been found that the cool temperature of the raw meat mixture facilitates the dicing step H. However, the cold meat may be brittle, and attempts to dice the meat too finely may cause excessive shattering of the raw meat, causing the particle size to be below desirable levels. It has been found that a two dimensional dicer with a 3/8″×3/8″ blade set provides good aggregate break-up and particle sizing without causing excessive waste due to shattering. Pre-dicing blades sets having a size of about 1/4″×1/4″ to about 1/2″×1/2″ also may be used. Blades sets as large as 1″×1″ also may be used for raw meat that has had larger pre-grind sizes in step B. Of course, it is anticipated that other size blades may be used to accommodate for variations in the temperature and grind size of the raw meat mixture and to create products having different final sizes for different uses.

Once diced, the raw meat mixture is spread onto a cooking belt in step K. The cooking belt conveys the raw meat mixture through one or more microwave ovens, belt grills, convection ovens or any other suitable convective, radiative or humidative cooker or the like. Combinations of ovens also may be used. Preferably, one or more of the ovens is independently controllable from the others to allow the temperatures of the individual ovens to be tailored to the state of the product passing therethrough.

In order to simplify processing, the meat is not agitated or mixed as it is conveyed through the one or more ovens. As such, it is important to spread the raw meat mixture evenly across the cooking belt to ensure even cooking and minimize waste. The step of spreading the meat onto the cooking belt preferably is performed by machinery that loads the meat onto the belt, and a human operator who evenly spreads the meat. It has been found that human operators provide superior spreading performance, however, it is envisioned that spreading may be performed by suitable machinery, such as a vibratory feed device that is able to evenly distribute the raw meat mixture.

It has been found that the ability to evenly spread the raw meat mixture onto the cooking belt is particularly influenced by at least three factors. First, the pre-dicing step breaks up aggregations of meat particles that are frozen together. Second, the cool temperature makes the meat particles flow more easily and reduces their tendency to adhere to one another. Third, the addition of salt generally causes the raw meat mixture to become sticky and does not spread well on a conveyor belt. Surprisingly, the inventors found that partial fermentation allowed for the salt to bind firmly to the meat while still allowing the meat to be easily ground and spread on a conveyor belt. The inventors discovered that fermentation to a pH above 6.3 yielded meat that does not bind enough salt and does not spread and if the pH was below 5.4 the taste of the meat product was too acidic. Based on the teachings herein, one of ordinary skill in the art will be able to vary these and other factors, particularly the dicing size and the temperature, to enhance the ability to spread the meat and obtain even cooking.

The cooking belt conveys the raw meat mixture through one or more ovens in the cooking step L. Current regulations of the food industry require the raw meat mixture to be cooked to a certain percentage of its original weight in order to qualify as a fully cooked bacon product. Conventionally prepared bacon product that is pumped and smoked prior to cooking must be reduced to approximately 40% of its green weight. Using the present process, however, the meat is not pumped and smoked down to green weight, and therefore the required 40% yield must be adjusted to take into account the formulated yield of the raw meat mixture (that is, the composition of the raw meat as it exits the mixer). It has been determined that, in a preferred embodiment, a weight reduction to approximately 36% of the uncooked weight provides the equivalent of a 40% yield of green weight, and qualifies the cooked product as fully cooked bacon product. Accordingly, it is preferred that the cooking step L of the present invention be able to reduce the weight of the raw meat mixture to about 36% of its original weight. It is further preferred that the present invention be able to provide a weight reduction to about 16 to 32% of the original weight in order to provide products having different qualities, such as size, texture, flavor, coloration and the like. Of course, other weight reductions, including weight reductions that do not satisfy the regulatory requirements of cooked bacon also may be provided by the present invention. It will be apparent that other methods of validating the cooked meat product may be used in addition to or in lieu of the above-described cook yield method. For example, time-temperature methods and instantaneous methods also may be used to validate the cooking of other types of product. Whatever method is used, it is preferred that the method be shown to provide a microbiological kill step that satisfies USDA or other standards for food preparation.

A number of different types of ovens may be used with the present invention, including microwave ovens, belt grills, convection ovens, and the like. Multiple ovens and combinations of different oven types also may be used with the present invention. In order to provide rapid control of product quality (as described below) and to eliminate unnecessary handling steps, it is preferred that the oven(s) be a continuous cooking oven rather than being a batch cooking oven. Continuous cooking ovens that process a substantially continuous supply of raw meat into a substantially continuous supply of cooked meat without interruption of the process, and typically comprise a continuously moving conveyor to carry the meat into and out of the oven. Furthermore, in order to reduce the complexity of the cooking operation and apparatus and increase the safety of the system, it is also preferred that the oven(s) be able to cook without the addition of fat or oil (or any other supplemental liquid heating medium), agitating the meat or the use of a pressure or vacuum chamber.

Microwave ovens have been found to provide good control of the cooking rate and quality of the final product, and are preferred. Preferably, a series of microwave ovens are placed end-to-end along the path of the cooking belt. In some cases, multiple ovens may be integrated into a single oven structure containing multiple cooking “cavities” that each contain a cooking unit. These cavities can be thought of as individual ovens, and single “ovens” having multiple cooking cavities are referred to herein as a series of ovens. In a preferred embodiment, a 5-cavity microwave oven is used, such as those available from Amana Commercial Products Division of Amana, Iowa under the designation QMP2103 RADARLINE.

The cooking temperature in each cavity (i.e., oven) preferably may be adjusted individually to provide an appropriate cooking rate, and the use of microwave ovens provides relatively fast adjustments to cooking parameters. For example, in one embodiment, earlier cavities operate at a higher energy level (typically measured in units of kilowatts) to heat the chilled and relatively moist raw meat mixture, while later cavities operate at a lower energy level to prevent overcooking. In a typical operation, the ovens operate to produce temperatures of about 180-210° Fahrenheit, although other temperatures may be used to accelerate or slow the cooking rate. It has been found that factors important to properly adjusting the microwave cavities include, inter alia: pre-dice size, raw meat mixture temperature, weight of product per unit area of the belt, and most importantly, the moisture content of the product (often correlated to the leanness of the meat) which can vary greatly from one pork belly to the next.

In order to ensure that the cooked meat obtains the desired final weight reduction, an iterative, feed-forward or feedback quality control process may be used to measure the cooked meat quality and make corresponding adjustments to the oven(s) performing the cooking step L. Such quality control steps are desirable because raw meat typically has variable properties, such as moisture content, fat content, and the like, that necessitate periodic or continuous adjustment of the oven(s) to ensure continued high quality output.

In one embodiment, the quality control process comprises weighing a sample of cooked meat, step M, and adjusting the cooking parameters, step N, if the weight is not suitable. Later weight measurements may be used to determine whether additional adjustments are necessary. Of course, any other quality control measurements also may be made to determine whether the cooked meat has the desired weight, color, flavor, texture and the like. Advantageously, the quality control process, steps M and N, may be used in conjunction with a continuous cooker to provide relatively rapid control of the output. If the output is found to be unsatisfactory, the oven or ovens may be adjusted to provide better results without sacrificing a large amount of product. This benefit is not possible with batch cooking ovens such as kettle cookers, because the final quality of the meat is unknown until all of the meat in the batch is cooked. In another embodiment, the quality control process, steps M and N, also may include a pre-cook diagnostic apparatus that determines the amount and/or density of raw meat mixture that is entering the ovens and automatically adjusts the oven output accordingly. An example of such a device and process is provided in U.S. Pat. No. 6,157,074, which is incorporated herein by reference. The use of multiple ovens also may allow quality control measurements of the meat to be taken between the ovens to further improve the quality of the final product.

During cooking, the meat heats to about 120° Fahrenheit, at which point the meat proteins begin to denature. Despite this denaturing, the meat tends to bond to itself to some degree during the cooking process because it is not agitated. As such, the meat emerges from the oven or ovens as a sheet of cooked meat. In a preferred embodiment, a breaker arm is used to break the sheet of cooked meat into chunks, step O, as it emerges from the oven. The breaker arm may comprise any device suited to break apart the sheet of cooked meat.

After being broken into chunks, the cooked meat is passed through a chilling room or chamber, step P, to reduce its temperature. Cooling the meat in the chilling room causes the fat on the surface of the meat to solidify on the product, rather on any subsequent machinery, which may reduce the efficiency of the machines, or on the final product packaging, which might cause unsightly smearing. Any commercially available chilling tunnel or chamber may be used for this step.

The final step of the cooking stage is to dice the cooked meat to its final size in the post-dice step Q. The post-dice step may be performed by any suitable dicing machine, such as those described above with reference to the pre-dice step J. The size of the dicing blade in the post-dicer may be varied to provide different size products for different applications or customers. In a preferred embodiment, the post-dicer has a 1/4″×1/4″ to 3/8″×3/8″ blade set for producing bacon bit products suitable as a garnishment for other foods. Other blade sets having a size of about 1/8″×1/8″ to about 1″×1″ also may be used in the post-dicer. In other embodiments, the blade sets may include non-square sets, such as a 1/4″×1″ blade set. Of course, it is anticipated that other size blades may be used to create products having different final sizes for different uses.

Various additional steps may be performed after the meat is cooked and diced to its final size. Referring now to FIG. 3, an exemplary post-cooking process is described. After the meat is cooked and diced to its final size, it is screened for metal inclusions, in step R, by a metal detector. In a preferred embodiment, the product is passed through a metal detector suitable for processing food. Suitable metal detectors are known in the art. Once screened, the product is classified by size, in step S, to separate larger bacon bits from smaller ones. Classifiers, such as shakers, also are known in the art. Once classified, the product is weighed, step T, and packaged, step U.

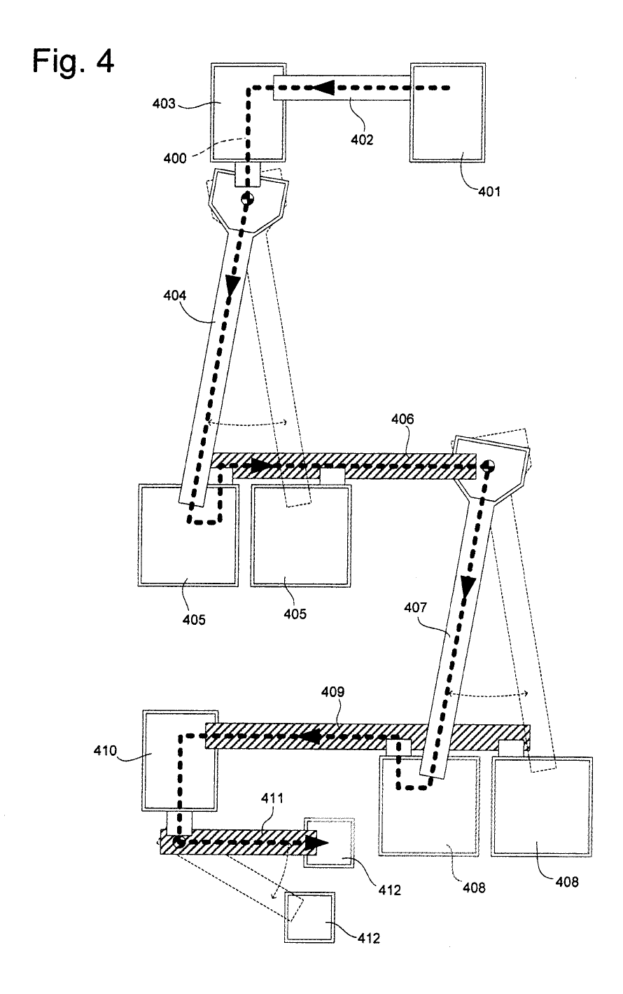

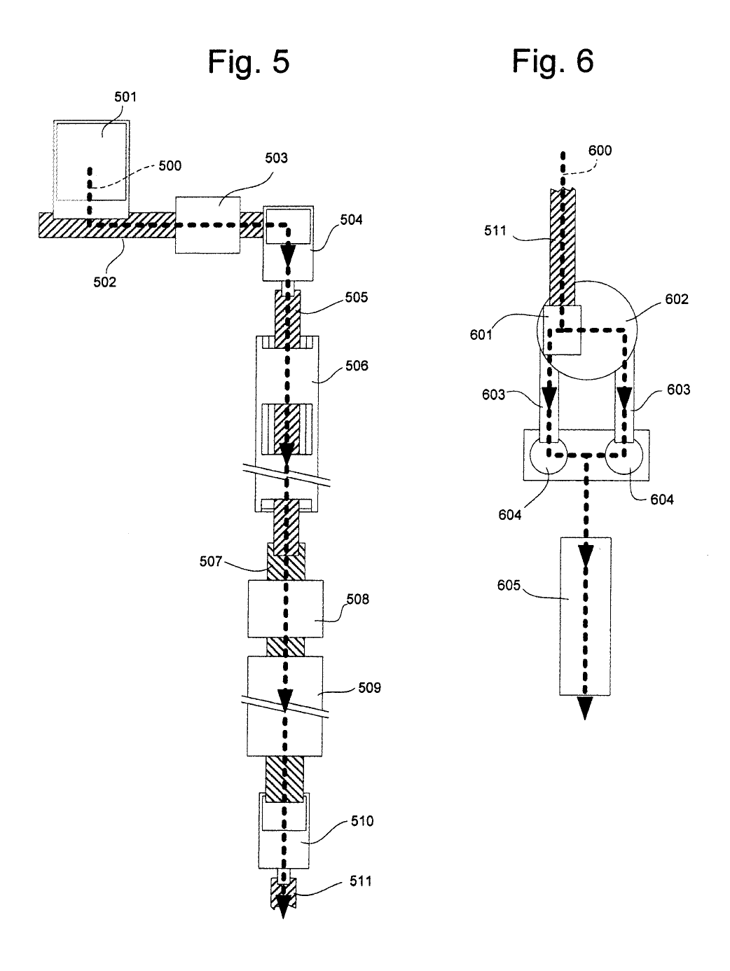

Having described numerous embodiments of the processing steps of the present invention in detail, various embodiments of processing apparatus for performing the process of the present invention will now be explained in detail with reference to FIGS. 4, 5, and 6. FIG. 4 depicts an apparatus for performing various steps of a mixing stage, FIG. 5 depicts an apparatus for performing various steps of a cooking stage, and FIG. 6 depicts an apparatus for performing various post-cooking processes.

FIG. 4 depicts an embodiment of an apparatus for performing various steps of an embodiment of a mixing stage. Path 400 demonstrates the typical path of the raw meat, however, as will be clear from the explanation below, the path may vary slightly during production to facilitate continuous operation. Raw meat, in the form of bellies or parts of bellies in the case of a bacon bit manufacturing operation, is provided to the apparatus by any suitable device, such as cardboard bins or containers (often referred to as “combos”). The raw meat is placed into a hopper 401 that feeds into a first screw conveyor 402 or similar device for inducting the raw meat into a first grinder 403.

The first grinder 403 grinds the meat to a specified size and passes the ground raw meat to a second screw conveyor 404. The second screw conveyor 404 carries the ground meat to one or more containers, known as “silos” 405. Although a fixed second screw conveyor 404 and single silo 405 may be used, it is preferred that the second screw conveyor 404 comprises a pivoting apparatus that rotates to convey the meat consecutive empty silos 405 whenever the target silo 405 is filled. This feature facilitates continuous operation of the process.

Each silo 405 comprises a load cell and a loss-in-weight controller that may be operated to dispense a known weight of meat from the silo. The silo or silos 405 preferably deposit the meat onto a first belt conveyor 406. The first belt conveyor 406 conveys the meat to a third screw conveyor 407. The third screw conveyor 407, preferably a pivoting conveyor, conveys the meat to one or more mixers 408. Again, a number of mixers 408 may be used to facilitate continuous operation of the process.

Each mixer preferably comprises a single-shaft, twin-shaft, or intermeshing twin-shaft mixer from Wolfking A/S of Denmark. Additional apparatus (not shown) may be used for depositing water, dry cure ingredients, starter culture, sugar, salt, a nitrate source (e.g., vegetable juice powder), liquid smoke, spices, and/or seasoning into each mixer 408, or this may be done manually. In addition, a coolant source, such as CO₂ nozzles may be fitted within or in the proximity of each mixer 408, or the mixers 408 may otherwise be equipped with cooling apparatus. In a preferred embodiment, the mixers 408 are also equipped with closable lids to facilitate cooling and prevent the escape of materials during mixing.

The mixers 408 preferably are equipped with augers to deposit the raw meat mixture, once it is fully mixed, onto a second belt conveyor 409. The second belt conveyor 409 conveys the raw meat mixture to a second grinder 410 (which may be any suitable grinder, such as those described with reference to the first grinder 403) for the final grinding step E. After being ground again, the raw meat mixture is deposited onto a third belt conveyor 411 and conveyed to one or more vats 412. As with the second and third screw conveyors 404, 407, the third belt conveyor may comprise a pivoting conveyor that rotates to deposit the raw meat mixture into successive empty vats to facilitate continuous processing. In other embodiments, the final grinding step E may be omitted and the second belt conveyor 409 may deposit the raw meat mixture directly into the vats 412. The vats 412 are conveyed, either automatically or by hand, to a storage room (not shown) which preferably is refrigerated to help keep the raw meat mixture cool. The raw meat mixture is preferably fermented for about 35 to 40° Fahrenheit for about 6 days at a pH below about 6.5 and above about 5.0.

FIG. 5 depicts an embodiment of an apparatus for performing various steps of an embodiment of a cooking stage. The process flow is shown generally by arrow 500. In the cooking stage, vats of chilled raw meat mixture are received by a dumping device 501 that conveys the raw meat mixture to a fourth belt conveyor 502. The fourth belt conveyor 400 deposits the raw meat mixture into a second grinder 503 for the second grinding step I and then into a first dicer 504 for the pre-dicing step J. A preferred dicer for this operation is the MODEL M DICER from Urschel Laboratories, Inc. of Valparaiso, Ind.

After the raw meat mixture is diced by the first dicer 504, it is deposited onto a cooking belt 505. As noted before, at this point the raw meat mixture preferably is spread uniformly across the cooking belt 505 to ensure that it is evenly cooked by the ovens 506. The cooking belt 505 should be selected to be compatible with the ovens 506, and may be supplied as an integrated part of the ovens 506, and preferably comprises a microwave transparent material that is USDA approved for food contact applications.

The cooking belt 505 conveys the meat through a series of one or more ovens 506 that cook the meat. As noted before, the one or more ovens preferably comprise microwave ovens, such as a 5-cavity QMP2103 RADARLINE Microwave from Amana Commercial Products Division of Amana, Iowa, but other types of oven may be used. The ovens 506 preferably comprise byproduct evacuation and ventilation means to remove liquefied fat, smoke, vapors and other cooking byproducts, and preferably are constructed from materials and in a manner that allows appropriate cleaning.

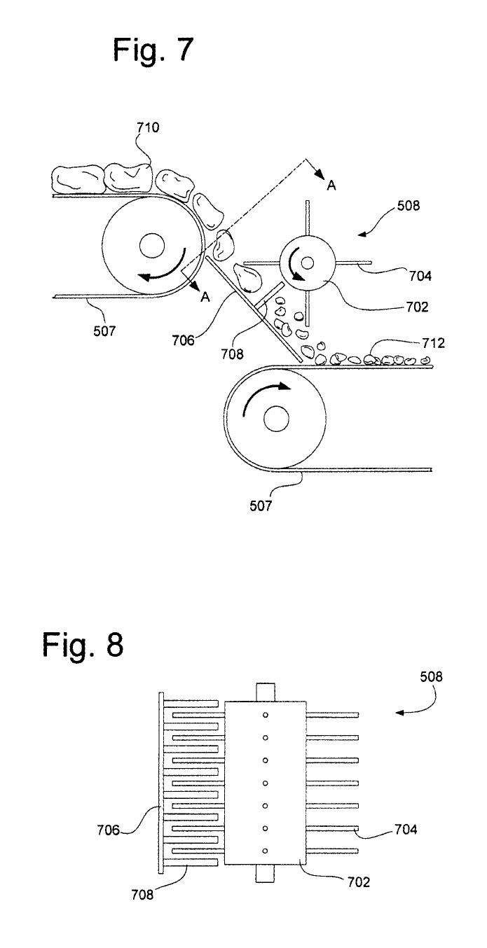

After exiting the ovens 506, the cooking belt 505 deposits the sheet-like cooked meat onto a fifth belt conveyor 507 that carries the cooked meat to a breaker arm assembly 508 or a similar device for breaking apart the cooked meat. Referring now to FIGS. 7 and 8, an embodiment of a preferred breaker arm is described. The preferred breaker arm assembly 508 is positioned between two parts of the fifth belt conveyor 507 and located to receive large chunks 710 of cooked meat as they exit the oven. The preferred breaker arm assembly 508 comprises a rotating assembly 702 comprising one or more rotating arms or paddles 704, and a base plate 706 comprising one or more fixed arms or paddles 708. As the rotating assembly 702 rotates, the rotating arms 704 pass between the fixed arms 708, as shown in FIG. 8, and break apart any large chunks 710 trapped between the rotating arms 704 and the fixed arms 708. A gap may be provided between the rotating arms 704 and fixed arms 708 to reduce the amount of shear that the cooked meat experiences. By changing the number, shape and size of the rotating arms 704 and fixed arms 708 and adjusting the gap between them, the amount of breakage and the size of the small chunks 712 that emerge from the breaker arm assembly 508 can be controlled. The base plate 706 acts as a slide to help convey the large and small chunks 710, 712 as they are being processed.

After passing through the breaker arm assembly 508, the cooked meat is conveyed through a chilling room 509 or an equivalent device, such as a commercial chilling tunnel, that reduces the temperature of the cooked meat.

The fifth belt conveyor 507 carries the cooked meat to a second dicer 510 for the post-dice step P. The second dicer 510 preferably comprises an Urschel MODEL M DICER, but alternatively may comprise any other suitable dicing machine. The diced cooked meat exits the second dicer 510 onto a sixth belt conveyor 511, which may comprise any suitable conveying apparatus.

FIG. 6 depicts an embodiment of an apparatus for performing various post-cooking processes, in which the process flow generally follows arrow 600. In the depicted embodiment, the cooked and diced meat is conveyed on the sixth belt conveyor 511 to a metal detector 601. After being screened for metal inclusions, the product is fed into a classifier 602 for sorting by different sizes. For convenience, the metal detector 601 may be mounted above the classifier 602 to feed the product into the classifier 602 by simple gravity feed. The classified product is conveyed by one or more screw conveyors 603 to scales 604, where the product is weighed for packaging. Once weighed, the product is packaged for sale or delivery by a packaging device 605.

Persons of ordinary skill in the art will appreciate that steps and processes described herein with reference to FIGS. 1, 2, and 3 may be performed in any suitable order, omitted, supplemented by other steps, modified or otherwise altered to produce suitable cooked meat products. The steps and processes herein also may, without undue experimentation, be modified to produce cooked meat products from meats other than pork, such as from beef, chicken and turkey, as will be understood by those of ordinary skill in the art. In addition, although the embodiments have been described with reference to certain preferred apparatus, it will be readily understood from the present teachings that similar devices may be used in place of many of the devices described herein. For example, it will be understood that belt conveyors may be split into multiple parts or replaced, in some instances with screw conveyors, or conveyors can be omitted or modified. Various devices also may be combined, or devices may be substituted by manual operators. Other variations will be apparent to those skilled in the art.

### EXAMPLES

The examples contained herein are offered by way of illustration and not by any way of limitation.

### Example 1

A dry cure comprising a lactic acid bacteria starter culture comprising about 160 g of a mixture of Pediococcus acidilactici and Staphyloccocus carnosus, about 30 pounds natural cane sugar, about 30 pounds sea salt, about 30 pounds water, about 12 pounds liquid smoke, about 12 pounds vegetable juice powder, spices, and seasoning can be added to about 1800 pounds of raw pork mixture comprising raw pork bellies (ends and pieces). The raw pork mixture comprising the dry cure can be fermented at about 35 to about 40° Fahrenheit (F) for about 6 days until the pH was below about 6.3 and above about 5.4. The fermented raw pork mixture is then processed substantially as described herein. This will yield about 540 pounds of cooked meat product (e.g., bacon bits).

### Example 2

A dry cure comprising a lactic acid bacteria starter culture comprising about 160 g of a mixture of Pediococcus acidilactici and Staphyloccocus carnosus, about 30 pounds natural cane sugar, about 30 pounds sea salt, about 30 pounds water, about 12 pounds liquid smoke, about 12 pounds vegetable juice powder, spices, and seasoning can be added to 1800 pounds of raw pork mixture comprising raw pork bellies (ends and pieces). The raw pork mixture comprising the dry cure can be fermented at about 35 to about 40° Fahrenheit for about 7 days until the pH was below about 6.3 and above about 5.4. The fermented raw pork mixture is then processed substantially as described herein. This will yield about 540 pounds of cooked meat product (e.g., bacon bits).

### Example 3

A dry cure comprising a lactic acid bacteria starter culture comprising about 160 g of a mixture of Pediococcus acidilactici and Staphyloccocus carnosus, about 30 pounds natural cane sugar, about 30 pounds sea salt, about 30 pounds water, about 12 pounds liquid smoke, about 12 pounds vegetable juice powder, spices, and seasoning can be added to about 1800 pounds of raw pork mixture comprising raw pork bellies (ends and pieces). The raw pork mixture comprising the dry cure can be fermented at about 35 to about 40° Fahrenheit for about 8 days until the pH was below about 6.3 and above about 5.4. The fermented raw pork mixture is then processed substantially as described herein. This will yield about 540 pounds of cooked meat product (e.g., bacon bits).

### Example 4

A dry cure comprising a lactic acid bacteria starter culture Chr. Hansen Product No. CS299 (Staphyloccoccus carnosus) [125 g] plus CSB [35 mL (˜35 g)] (a mixture of Pediococcus acidilactici and Staphylococcus carnosus), about 30 pounds natural cane sugar, about 30 pounds sea salt, about 30 pounds water, about 12 pounds Red Arrow LF-BN® brand liquid smoke, about 12 pounds vegetable juice powder, spices, and seasoning can be added to about 1800 pounds of raw pork mixture comprising raw pork bellies (belly pieces and/or trim). The raw pork mixture comprising the dry cure can be fermented at about 35 to about 40° Fahrenheit for about 7 days until the pH was below about 6.3 and above about 5.4. The fermented raw pork mixture is then processed substantially as described herein. This will yield about 540 pounds of cooked meat product (e.g., bacon bits).

### Example 5

A dry cure comprising a lactic acid bacteria starter culture comprising about 125 g of at least one Micrococcus species or Staphylococcus species to convert nitrate to nitrite and impart the typical cured pink color and about 35 g of at least one Lactobacillus species or Pediococcus species for fermentation (e.g., lactic acid production), about 30 pounds natural cane sugar, about 30 pounds sea salt, about 30 pounds water, about 12 pounds natural liquid smoke, about 12 pounds vegetable juice powder, spices, and seasoning can be added to about 1800 pounds of raw pork mixture comprising raw pork bellies (belly pieces or trim). The raw pork mixture comprising the dry cure can be fermented at about 35 to about 40° Fahrenheit for about 7 days until the pH was below about 6.5 and above about 5.0. The fermented raw pork mixture is then processed substantially as described herein. This will yield about 540 pounds of cooked meat product (e.g., bacon bits).

Although the invention has been described in some detail by way of illustration and example for purposes of clarity of understanding, it will be obvious that certain changes and modifications may be practiced within the scope of the appended claims. Modifications of the above-described modes for carrying out the invention that are obvious to persons of skill in food processing, fermentation, microbiology, nutritional, agricultural, and/or related fields are intended to be within the scope of the following claims.

All publications and patent applications mentioned in this specification are indicative of the level of skill of those skilled in the art to which this invention pertains. All such publications and patent applications are herein incorporated by reference to the same extent as if each individual publication or patent application was specifically and individually indicated to be incorporated by reference.

1. A method for preparing particulate cooked meat products, the method comprising:
(a) reducing raw meat to a first size;
(b) mixing the raw meat with dry cure and a starter culture to form a raw meat mixture;
(c) cooling the raw meat mixture;
(d) storing the raw meat mixture to allow fermentation.
wherein said raw meat mixture is stored long enough to allow for partial fermentation but not full fermentation;
(e) further reducing the raw meat mixture;
(f) spreading the raw meat mixture onto a cooking surface; and
(g) cooking the raw meat mixture in one or more ovens to form a cooked meat mixture.

2. The method of claim 1, wherein the raw meat comprises raw pork belly meat.

3. The method of claim 1, wherein said starter culture comprises lactic acid bacteria.

4. The method of claim 1, wherein said starter culture comprises one or more Micrococcus species, Staphylococcus species, Lactobacillus species, or Pediococcus species.

5. The method of claim 4, wherein said starter culture comprises a mixture of one or more Micrococcus species or Staphylococcus species and one or more of a Lactobacillus species or Pedicoccus species.

6-9. (canceled)

10. The method of claim 1, wherein said raw meat mixture is fermented until its pH is below about 6.5.

11. The method of claim 10, wherein said raw meat mixture is fermented until its pH is below about 6.3.

12. The method of claim 1, wherein said raw meat mixture is fermented until its pH is above 5.0.

13. The method of claim 12, wherein said raw meat mixture is fermented until its pH is above 5.4.

14. The method of claim 1, wherein the cooling step of said raw meat mixture cools said raw meat mixture to about 30° to about 45° Fahrenheit.

15. The method of claim 1, wherein the storage step of said raw meat mixture is at about 30° to about 45° Fahrenheit.

16. (canceled)

17. The method of claim 1, wherein said raw meat mixture is stored to allow fermentation for about 6 to about 8 days.

18. The method of claim 17, wherein said raw meat mixture is stored to allow fermentation for about 7 days.

19. The method of claim 1, wherein sugar is added to the raw meat mixture.

20. (canceled)

21. The method of claim 1, wherein salt is added to the raw meat mixture.

22. (canceled)

23. The method of claim 1, wherein liquid smoke is added to the raw meat mixture.

24. (canceled)

25. The method of claim 1, wherein vegetable juice powder is added to the raw meat mixture.

26. (canceled)

27. The method of claim 1, wherein the wherein the step of cooling the raw meat mixture comprises: cooling the raw meat mixture during the mixing step to a first temperature; and cooling the raw meat mixture after the mixing step to a second temperature.

28-37. (canceled)

38. The method of claim 1 wherein the step of cooking the raw meat mixture further comprises cooking the raw meat mixture at a temperature of about 180 to about 210° Fahrenheit.

39. (canceled)

40. A cooked meat mixture obtained by the method of claim 1.

41. (canceled)
